(19) United States
(12) Patent Application Publication
(10) Pub. No.: US 2026/0313497 A1
(43) Pub. Date: Oct. 8, 2026

(54) CONNECTION RECOVERY IN WIRELESS COMMUNICATIONS

(71) Applicant: LG ELECTRONICS INC., Seoul (KR)

(72) Inventors: Hongsuk KIM, Seoul (KR); Sunghoon JUNG, Seoul (KR); Siyoung CHOI, Seoul (KR)

(73) Assignee: LG ELECTRONICS INC., Seoul (KR)

(21) Appl. No.: 19/482,498

(22) PCT Filed: May 8, 2024
(86) PCT No.: PCT/KR2024/006186

§ 371 Date: Nov. 7, 2025

Related U.S. Application Data
(60) Provisional application No. 63/465,871, filed on May 11, 2023.

(51) Int. Cl. H04W 36/08

(52) U.S. Cl. CPC H04W 36/08

(57) ABSTRACT

The present disclosure is related to connection recovery in wireless communications. According to an embodiment of the present disclosure, a communication device may select a candidate cell for a connection re-establishment with a network among one or more configured cell switch candidate cells, when detecting a cell switch failure. The communication device may transmit, to the network, a request message for the connection re-establishment with the network via the selected cell. The communication device may receive, from the network, a response message comprising an instruction to apply a configuration of the selected cell. The communication device may apply the configuration of the selected cell based on the instruction.

### CROSS-REFERENCE TO RELATED APPLICATIONS

This application is the National Stage filing under 35 U.S.C. 371 of International Application No. PCT/KR2024/006186, filed on May 8, 2024, which claims the benefit of U.S. Provisional Application No. 63/465,871 filed on May 11, 2023, the contents of which are all hereby incorporated by reference herein in their entireties.

### TECHNICAL FIELD

The present disclosure is related to connection recovery in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a communication device may detect various types of failures, such as a radio link failure (RLF) or a mobility failure. When the failure occurs, the communication device may need to perform a connection re-establishment for connection recovery. However, the connection re-establishment takes some time, which may cause latency and late connection recovery.

### SUMMARY

An aspect of the present disclosure is to provide method and apparatus for connection recovery in a wireless communication system.

According to an embodiment of the present disclosure, a method performed by a communication device adapted to operate in a wireless communication system comprises: receiving, from a network, a cell switch configuration comprising one or more configurations of one or more candidate cells; receiving, from the network, a cell switch command for a first candidate cell among the one or more candidate cells; performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

According to an embodiment of the present disclosure, a method performed by a network node configured to operate in a wireless communication system comprises: transmitting, to a communication device, a cell switch configuration comprising one or more configurations of one or more candidate cells; and transmitting, to the communication device, a cell switch command for a first candidate cell among the one or more candidate cells, wherein the communication device is configured to perform operations comprising: performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

According to various embodiments, apparatuses to implement the above methods are provided.

The present disclosure may have various advantageous effects.

For example, UE performs RRC re-establishment but can resume data transmission based on the given (pre)configuration (e.g., cell switch configuration) when RRC re-establishment procedure is completed. Thus, the UE can reduce the delay/latency of the data transmission than the case that the UE can start data transmission after reception of the first RRC reconfiguration after RRC re-establishment.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a dual connectivity (DC) architecture to which technical features of the present disclosure can be applied.

FIG. 9 shows an example of a conditional mobility procedure according to an embodiment of the present disclosure.

FIG. 10 shows an example of a signaling procedure for LTM according to an embodiment of the present disclosure.

FIG. 11 shows an example of a method performed by a communication device for connection recovery when cell switch failure occurs according to an embodiment of the present disclosure.

FIG. 12 shows an example of a procedure for connection recovery when cell switch failure occurs according to an embodiment of the present disclosure.

FIG. 13 shows an example of a procedure for RRC re-establishment enhancement based on LTM according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

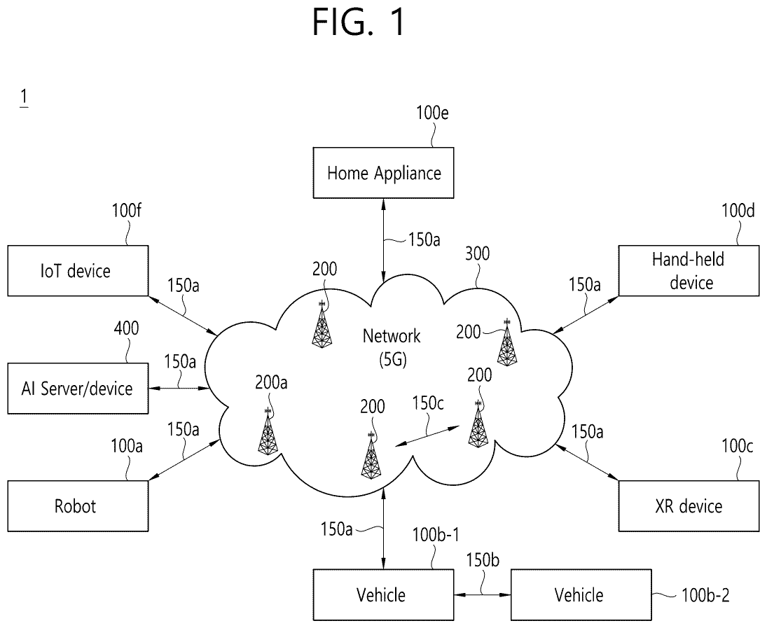

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

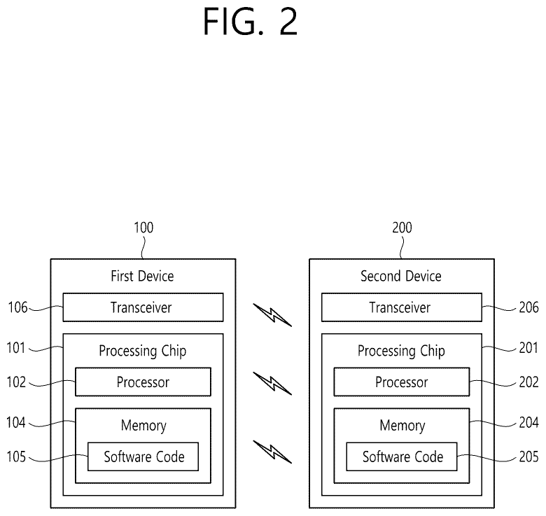

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

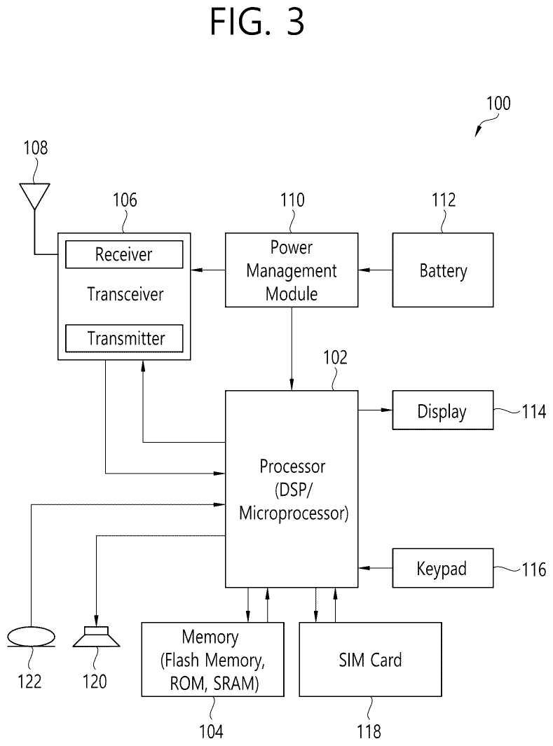

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

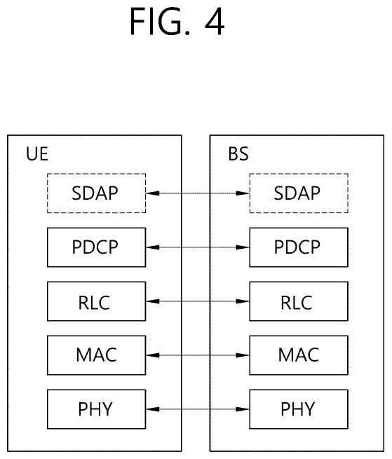

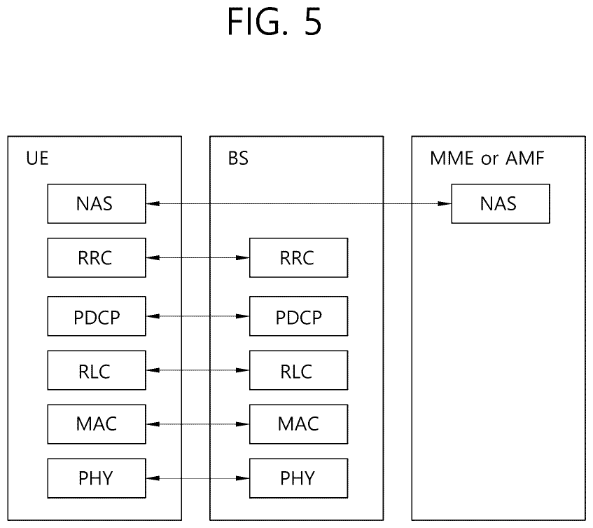

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

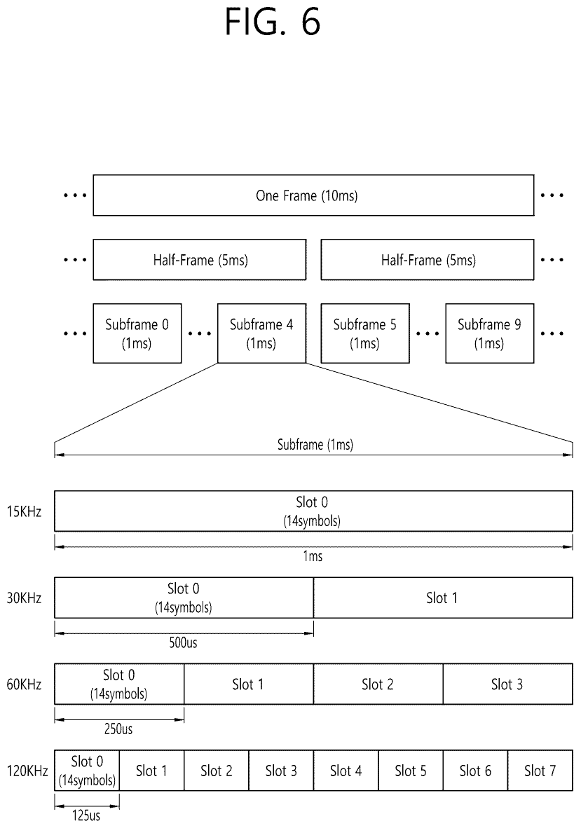

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{μ}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{μ}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{μ}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 kHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

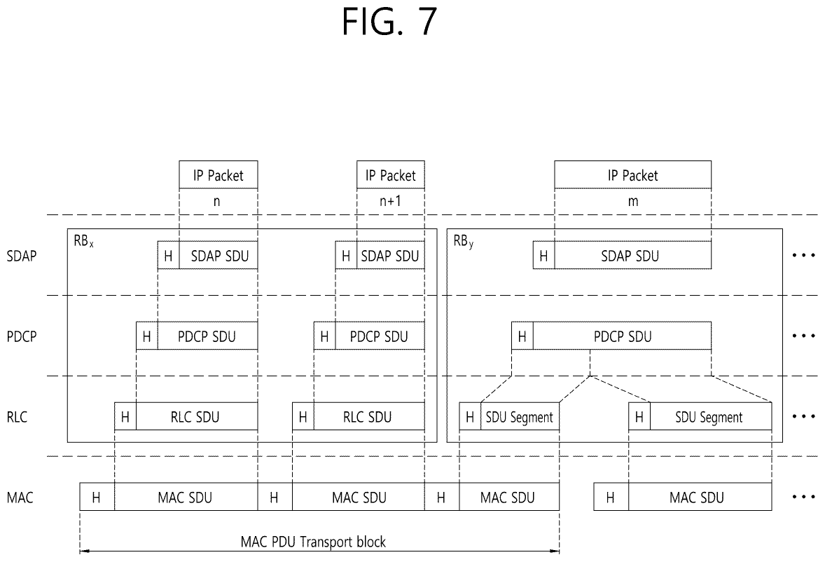

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

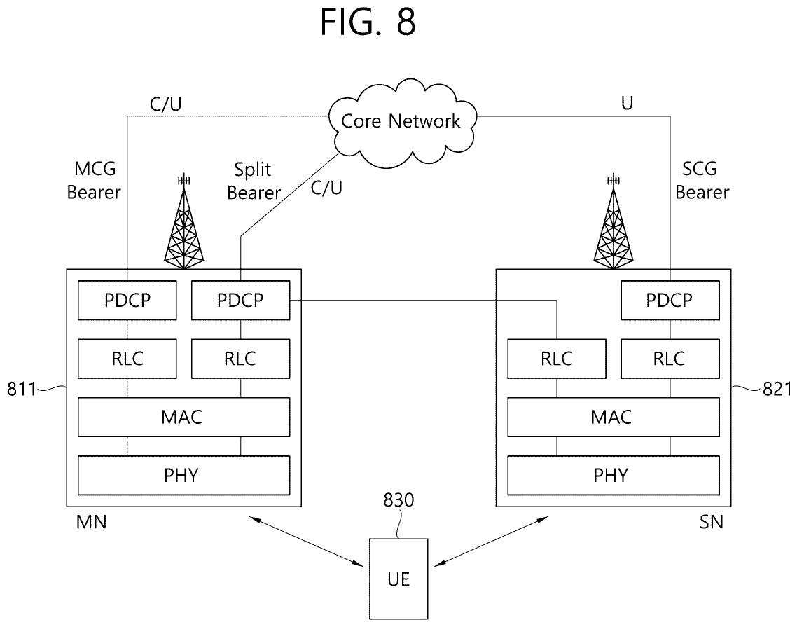

FIG. 8 shows an example of a dual connectivity (DC) architecture to which technical features of the present disclosure can be applied.

Referring to FIG. 8, MN 811, SN 821, and a UE 830 communicating with both the MN 811 and the SN 821 are illustrated. As illustrated in FIG. 8, DC refers to a scheme in which a UE (e.g., UE 830) utilizes radio resources provided by at least two RAN nodes comprising a MN (e.g., MN 811) and one or more SNs (e.g., SN 821). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 811) refers to a main RAN node providing services to a UE in DC situation. SN (e.g., SN 821) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 8, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 8, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 8, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 8, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, contents regarding mobility are described.

The mobility may comprise PCell change, PSCell change (or, secondary node (SN) change), and/or PSCell addition (or, SN addition).

In the present disclosure, the term “handover (HO)” may mean PCell change, or may be a broad concept that includes not only PCell change but also PSCell change/addition.

In the present disclosure, the terms “handover” and “mobility” can be used interchangeably.

In the present disclosure, the description regarding handover can also be applied to other mobility procedures (e.g., PSCell change/addition).

There may be at least two types of mobility: network-controlled mobility (or, legacy mobility) and UE-based mobility (or, conditional mobility).

The network-controlled mobility (or, legacy mobility) is a mobility where the network determines a target cell for mobility, and configures UE with the target cell. The network may transmit, to the UE, an RRCReconfiguration message comprising a configuration for the target cell. The UE may execute a mobility to the target cell and/or apply the configuration for the target cell, upon receiving the cell configuration for the target cell.

The UE-based mobility (or, conditional mobility) is a mobility where the network configures the UE with a plurality of candidate cells, and the UE determines a target cell which satisfies a mobility execution condition among the plurality of candidate cells. The conditional mobility may comprise at least one of a conditional PCell change/conditional handover (CHO) or a conditional PSCell mobility. The conditional PSCell mobility may comprise conditional PSCell addition/change (CPAC), including conditional PSCell addition (CPA) and/or conditional PSCell change (CPC). The network may transmit, to the UE, an RRCReconfiguration message comprising ConditionalReconfiguration information element (IE), which comprises a list of conditional reconfigurations for the plurality of candidate cells. A conditional reconfiguration for a candidate cell may comprise an identifier of the conditional reconfiguration, a mobility execution condition for the candidate cell, and a configuration for the candidate cell. The UE may evaluate the mobility execution conditions for the plurality of candidate cells, and when a mobility execution condition for a candidate cell is satisfied, the UE may consider the candidate cell as a target cell, and execute a mobility to the target cell and/or apply the configuration for the target cell.

According to various embodiments, the mobility execution condition may be satisfied/met when an entry condition (or, entering condition) for the mobility execution condition is satisfied/met for at least a time-to-trigger (TTT) for the mobility execution condition. The entry condition/entering condition may mean that the mobility execution condition is initially met. Once the entry condition is met, the mobility execution condition will be considered to be met if the entry condition is met for time duration TTT continuously.

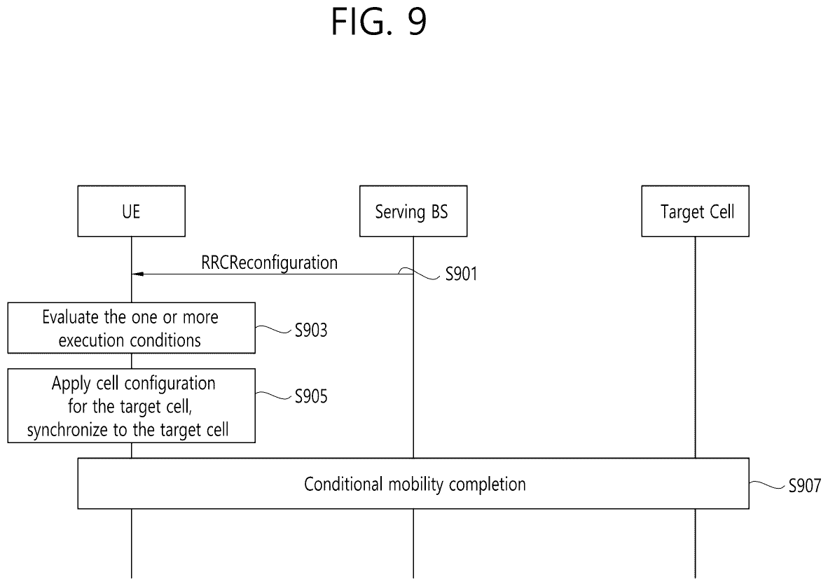

FIG. 9 shows an example of a conditional mobility procedure according to an embodiment of the present disclosure.

In FIG. 9:
the serving BS may be related to a PCell, which may be a source PCell for CHO;
the serving BS may be an MN associated with an SN in DC, where the SN may be related to a source PSCell for CPC; and
the target cell may be a target PCell for CHO, or a target PSCell for CPA/CPC.

Referring to FIG. 9, in step S901, UE may receive, from the serving BS, an RRCReconfiguraiton message comprising a conditional reconfiguration information element (IE) (i.e., CondidtionalReconfiguration). The conditional reconfiguration IE may comprise a list of conditional reconfigurations for candidate cells including the target cell. Each conditional reconfiguration in the list may be related to the corresponding candidate cell, and comprises i) an identifier of the corresponding conditional reconfiguration (i.e., condReconfigId), ii) one or more execution conditions for the corresponding candidate cell (i.e., condExecutionCond), and/or iii) RRC reconfiguration for the corresponding candidate cell (i.e., condRRCReconfig) including a cell configuration for the corresponding candidate cell. The one or more execution conditions may comprise CHO execution condition(s), CPA execution condition(s), and/or CPC execution condition(s).

In step S903, the UE may start evaluating the one or more execution conditions for the candidate cells.

In step S905, if the target cell satisfies the corresponding execution condition(s), the UE may execute the conditional mobility towards the target cell and/or apply the RRC reconfiguration for the target cell including a cell configuration for the target cell. When/upon executing the conditional mobility and/or applying the RRC reconfiguration for the target cell, the UE may start a timer (e.g., T304 timer). While the timer is running, the UE may perform DL synchronization and/or UL synchronization (e.g., random access) towards the target cell. The UE may skip the random access towards the target cell if timing advance (TA) information for the target cell is available.

In step S907, the UE, serving BS and/or BS related to the target cell may perform actions related to conditional mobility completion. For example, upon successful completion of the random access on the corresponding target cell, the UE may stop the timer (e.g., T304 timer).

Further, there may be another type of mobility called L1/L2-triggered mobility (LTM). LTM is a procedure in which a gNB receives L1 measurement reports from UEs, and on their basis the gNB changes UEs' serving cell(s) through MAC CE. The gNB prepares one or multiple candidate cells and provides the candidate cell configurations to the UE through RRC message. Then LTM cell switch is triggered, by selecting one of the candidate configurations as target configuration for LTM by the gNB. The candidate cell configurations can only be added, modified and released by network via RRC signaling. The LTM may also be referred to as “cell switch”.

An LTM candidate cell may be configured via a RRCReconfiguration message for candidate target cell, and/or a CellGroupConfig IE for each candidate target cell.

The following principles may apply to LTM:
User plane is continued whenever possible (e.g., intra-distributed unit, DU), without reset, with the target to avoid data loss and the additional delay of data recovery.
Security is not updated in LTM.
Subsequent LTM between candidates (i.e., UE does not release other candidate cell configurations after LTM is triggered) can be performed without RRC reconfiguration.

LTM supports both intra-gNB-DU and intra-gNB-CU inter-gNB-DU mobility. LTM also supports inter-frequency mobility, including mobility to inter-frequency cell that is not a current serving cell. The following scenarios may be supported:
PCell change in non-CA scenario,
PCell change without SCell change in CA scenario,
PCell change with SCell change(s) in CA scenario, including the following cases:
a) The target PCell/target SCell(s) is not a current serving cell (CA-to-CA scenario with PCell change)
b) The target PCell is a current SCell
c) The target SCell is the current PCell.
Dual connectivity scenario, at least for the PSCell change without MN involvement case, i.e. intra-SN.

Inter-cell beam management is also supported, but is not considered as a prerequisite for using LTM.

The design for intra-DU and inter-DU L1/L2-based mobility should share as much commonality as reasonable.

In some implementations, validity/compliance check of candidate cell configuration are performed upon reception of the candidate cells configuration.

Cell switch trigger information is conveyed in a MAC CE, which contains at least a candidate configuration index. Cell-specific, radio bearer, and measurement configurations can be part of an LTM candidate cell configuration.

In some implementations, the MAC CE can indicate TCI state(s) (or other beam information) to be activated for the target cell(s)

In some implementations, it is possible to perform SCell activation/deactivation (amongst SCells associated with the candidate configuration) simultaneously with the LTM triggering MAC CE.

UE may perform contention-based random access (CBRA) or contention-free random access (CFRA) at cell switch. UE may also skip random access procedure if UE doesn't need to acquire timing advance (TA) for the target cell during cell switch. RACH resources for CFRA are provided in RRC configuration.

In some implementations, the CFRA resources can be provide via MAC CE.

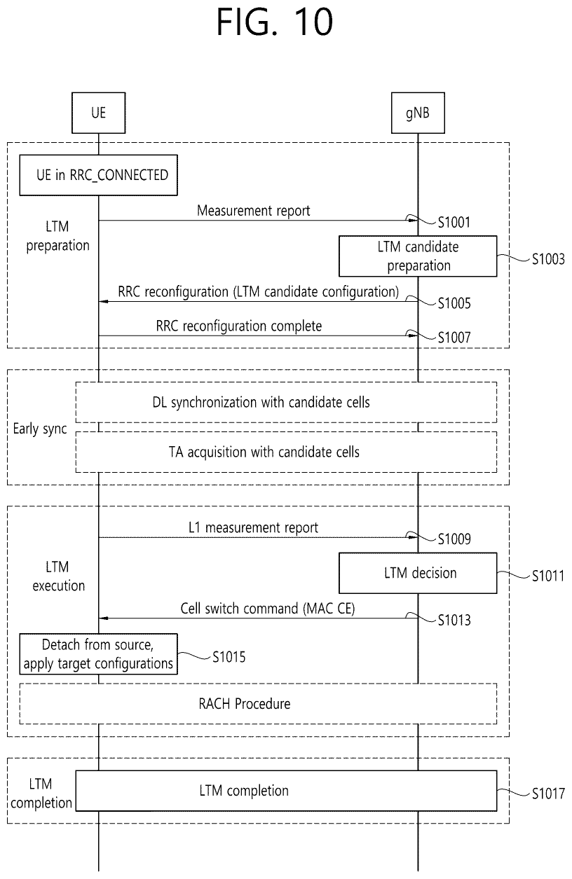

The overall procedure for LTM is shown in FIG. 10 below. Subsequent LTM is done by repeating the early synchronization, LTM execution, and LTM completion steps without releasing other candidates after each LTM completion.

FIG. 10 shows an example of a signaling procedure for LTM according to an embodiment of the present disclosure.

Referring to FIG. 10, in step S1001, UE may send a MeasurementReport message to gNB.

In step S1003, the gNB may decide to use LTM and initiate LTM candidate preparation.

In step S1005, the gNB may transmit an RRCReconfiguration message to the UE including the configuration of one or multiple LTM candidate target cells (i.e., cell switch configuration). The configuration of one or multiple LTM candidate target cells and/or cell switch configuration may comprise candidate cell configuration(s) of the one or multiple LTM candidate target cells.

The candidate cell configuration (for LTM/cell switch) can be provided as delta configuration on top of a reference configuration. That is, the candidate cell configuration as delta configuration may be applied on top of the reference configuration to form a complete candidate configuration. The reference configuration may be managed separately, and UE may store the reference configuration as a separate configuration. Alternatively, the reference configuration may not be a separate configuration but may be the current (UE) configuration. Combination of the reference configuration and LTM candidate configuration (as delta configuration) may form a complete configuration (for LTM/cell switch to a candidate cell).

In some implementations, the reference configuration may be the complete configuration. In this case, delta configuration may not be required to form the complete configuration. Whether the reference configuration is a complete configuration or not (i.e., incomplete configuration) may be up to network implementation.

In some implementations, the reference configuration may be empty. In this case, delta configuration may be the complete configuration.

The reference configuration may be explicitly signalled (i.e., may not be automatically derived from any other configuration, such as the current (UE) configuration). Alternatively, the reference configuration may be derived from the current (UE) configuration.

The complete candidate configuration may be applied and may replace the current UE configuration (at the time of reconfiguration/LTM execution/cell switch), by a RRC reconfiguration procedure that makes replacements of configuration but doesn't necessarily reset RLC and/or PDCP. Alternatively, it may be possible that the RRC reconfiguration procedure resets RLC and/or PDCP.

In step S1007, the UE may store the configuration of LTM candidate target cell(s) and transmit a RRCReconfigurationComplete message to the gNB.

In some implementations, the UE may optionally perform early synchronization (or, DL/UL synchronization management) with candidate cell(s). In this case, the UE may perform DL synchronization and/or UL synchronization (e.g., TA acquisition) with candidate target cell(s) before receiving the LTM cell switch command.

For example, DL synchronization for candidate cell(s) before cell switch command may be supported, at least based on SSB.

For example, TA acquisition of candidate cell(s) before LTM cell switch command may be supported, at least based on PDCCH ordered RACH, where the PDCCH order is only triggered by source cell.

The UE may perform the early synchronization before step S1009, after step S1009, or during step S1009.

In step S1009, UE may perform L1 measurements on the configured LTM candidate target cell(s), and transmit lower-layer measurement reports to the gNB. The lower-layer measurement reports may be carried on L1 or MAC.

In step S1011, the gNB may decide to execute LTM cell switch to a target cell.

In step S1013, the gNB may transmit a cell switch command MAC CE triggering LTM cell switch by including the candidate configuration index of the target cell. That is, the UE may receive, from the gNB, the cell switch command MAC CE triggering LTM cell switch by including the candidate configuration index of the target cell. The UE may switch to the configuration of the LTM candidate target cell.

In various embodiments, LTM supervisor timer (or, LTM timer) is introduced. The LTM supervisor timer may be configured to the UE from the gNB via RRC signalling. The UE may start the LTM supervisor timer upon reception of the LTM cell switch MAC CE (i.e., cell switch command MAC CE).

In step S1015, UE may detach from the source cell, and apply the target cell configuration(s). If TA is not available, the UE may perform a random access procedure (or, RACH procedure) towards the target cell.

In step S1017, the UE may indicate successful completion of the LTM cell switch towards the target cell. The UE may stop the LTM supervisor timer, upon successful completion of the LTM cell switch.

In some implementations, an uplink signal or message after the UE has switched to the target cell may be used to indicate successful completion of the LTM cell switch.

In some implementations, if the LTM supervisor timer for MCG expires, as baseline, the UE may consider that LTM failure (or, LTM execution failure) is detected and initiate RRC (connection) re-establishment. At RLF and/or LTM execution failure (for MCG), the UE may perform a fast (failure) recovery to an LTM candidate cell by LTM execution.

In FIG. 10, the RACH procedure can be skipped (i.e., UE may perform a RACH-less mobility to the target cell), when a RACH-skip condition is satisfied. The RACH-skip condition may comprise one or more of the following conditions:
TA information of the target cell is available to the UE and/or TA of the target cell is valid;
beam indication of the target cell is available to the UE and/or no beam failure is detected on the target cell; or
uplink (UL) grant for transmitting the uplink signal indicating successful completion of the LTM cell switch is available to the UE.

When performing the random access procedure/RACH procedure: i) the UE may perform a contention-free random access (CFRA) if CFRA resources/dedicated RACH configuration is available to the UE; and ii) the UE may perform a contention-based random access (CBRA) if CFRA resources/dedicated RACH configuration is not available to the UE.

For the CBRA, the UE may transmit a random access preamble in uplink, to a RAN node. The UE may transmit a message 1 (MSG1) comprising the random access preamble to the RAN node. The random access preamble may be associated with a random access-radio resource temporary identifier (RA-RNTI). The random access preamble may be selected based on the selected RACH resources, and transmitted through a time/frequency resources identified by the selected RACH resources.

For the CFRA, the UE may transmit a dedicated random access preamble in uplink, to a RAN node. The UE may transmit an MSG1 comprising the dedicated random access preamble to the RAN node. The dedicated random access preamble may be associated with a RA-RNTI. The dedicated random access preamble may be selected based on the CFRA resources/dedicated RACH configuration, and transmitted through a time/frequency resources identified by the CFRA resources/dedicated RACH configuration.

In the present disclosure, subsequent mobility (e.g., subsequent CHO/CPC/CPA/LTM) is described. The subsequent mobility may refer to a mobility that is performed without reconfiguration and/or re-initialization from a network after a previous mobility. For example, when a mobility is performed based on receiving a plurality of mobility configurations including a configuration for the mobility, a subsequent mobility may be performed based on a configuration among the already received plurality of mobility configurations, without reconfiguration and/or re-initialization (or, without receiving new configuration(s)) from the network.

Meanwhile, LTM is introduced in order to reduce latency, overhead and/or interruption time. For LTM, the network may provides the UE in advance with one or more configurations of one or more candidate serving cells (i.e., (pre)configuration of candidate cells for LTM/cell switch configuration). Then the UE may perform L1 measurement of the candidate cells and report the L1 measurement result to the network. The network may determine the UE executes LTM to the candidate cell based on the L1 measurement reporting. The network transmits, to the UE, the LTM cell switch command via L1/L2 signaling to trigger for the UE to execute the LTM toward the candidate cell. Upon receiving the LTM cell switch command, the UE initiates the cell switch procedure (i.e., LTM execution to the candidate cell).

However, when LTM cell switching is failed, if the UE-based failure recovery cannot be initiated or is also failed while RRC re-establishment procedure, the UE cannot maintain the (pre)configuration for LTM (i.e., cell switch configuration) due to the re-establishment of RRC connection and the UE shall remove all dedicated configurations and/or perform MAC reset. As a result, data delay may occur until a reception of the first RRC reconfiguration for data transmission is provided after RRC re-establishment procedure.

Therefore, the present disclosure provides various embodiments for connection recovery when cell switch failure occurs.

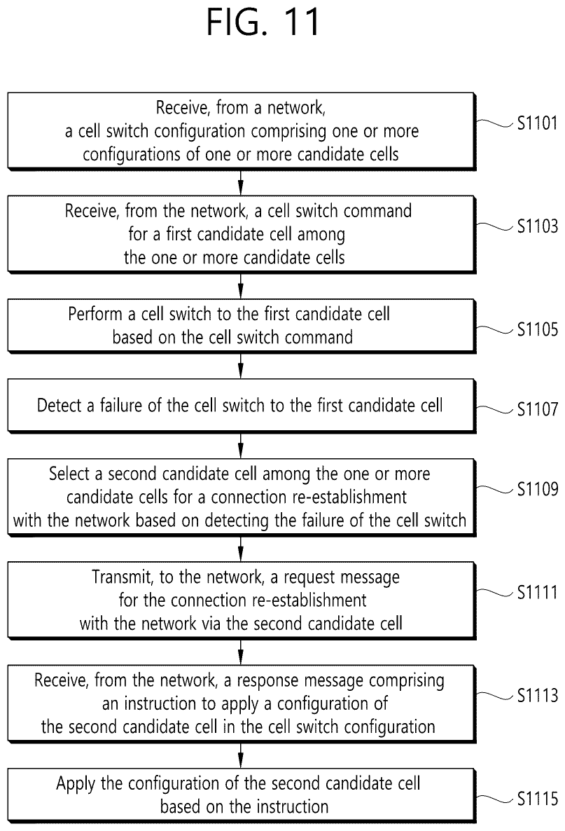

FIG. 11 shows an example of a method performed by a communication device for connection recovery when cell switch failure occurs according to an embodiment of the present disclosure.

Referring to FIG. 11, in step S1101, the communication device may receive, from a network, a cell switch configuration comprising one or more configurations of one or more candidate cells.

In step S1103, the communication device may receive, from the network, a cell switch command for a first candidate cell among the one or more candidate cells.

In step S1105, the communication device may perform a cell switch to the first candidate cell based on the cell switch command.

In step S1107, the communication device may detect a failure of the cell switch to the first candidate cell.

In step S1109, the communication device may select a second candidate cell among the one or more candidate cells for a connection re-establishment with the network based on detecting the failure of the cell switch.

In step S1111, the communication device may transmit, to the network, a request message for the connection re-establishment with the network via the second candidate cell.

In step S1113, the communication device may receive, from the network, a response message comprising an instruction to apply a configuration of the second candidate cell in the cell switch configuration.

In step S1115, the communication device may apply the configuration of the second candidate cell based on the instruction.

According to various embodiments, the configuration of the second candidate cell in the cell switch configuration may comprise a complete cell configuration for the second candidate cell. The communication device may apply the complete configuration for the second candidate cell.

According to various embodiments, the configuration of the second candidate cell in the cell switch configuration may comprise a candidate configuration for the second candidate cell. The communication device may construct a complete configuration for the second candidate cell based on applying the candidate configuration for the second candidate cell to a reference configuration related to at least one of the candidate configuration or the second candidate cell. The communication device may apply the complete configuration for the second candidate cell.

According to various embodiments, the reference configuration may be received from the network or derived from a current configuration of the communication device.

According to various embodiments, the reference configuration may be included in the cell switch configuration.

According to various embodiments, the communication device may start a timer (e.g., LTM supervisor timer) upon receiving the cell switch command for the first candidate cell. The communication device may perform the cell switch to the first candidate cell while the timer is running. The communication device may detect the failure of the cell switch to the first candidate cell upon an expiry of the timer.

According to various embodiments, when the communication device detects an RLF on a source cell related to the cell switch, the communication device may detect the failure of the cell switch.

According to various embodiments, the connection re-establishment may comprise a radio resource control (RRC) re-establishment. The request message may comprise RRC re-establishment request message. The response message may comprise RRC re-establishment message.

According to various embodiments, after applying the configuration of the second candidate cell, the communication device may transmit, to the network, a complete message informing a completion of the connection re-establishment which is based on the configuration of the second candidate cell.

According to various embodiments, the complete message may comprise a radio resource control (RRC) re-establishment complete message.

According to various embodiments, the communication device may receive a configuration for L1/L2 based mobility (i.e., LTM) from a network. The configuration for L1/L2 based mobility (i.e., cell switch configuration) may include one or more candidate cells, related cell configurations, and/or reference configuration. The communication device may declare a failure of a mobility after receiving a command via L1/L2 signaling for the L1/L2 based mobility. The communication device may perform a cell selection to re-establish a connection with the network. The communication device may receive, from the network, an indication allowing that the communication device can re-use the related cell configuration based on the reference configuration while re-establishing the connection. The communication device may apply the related cell configuration with the newly selected cell based on the reference configuration and send a response message to the network.

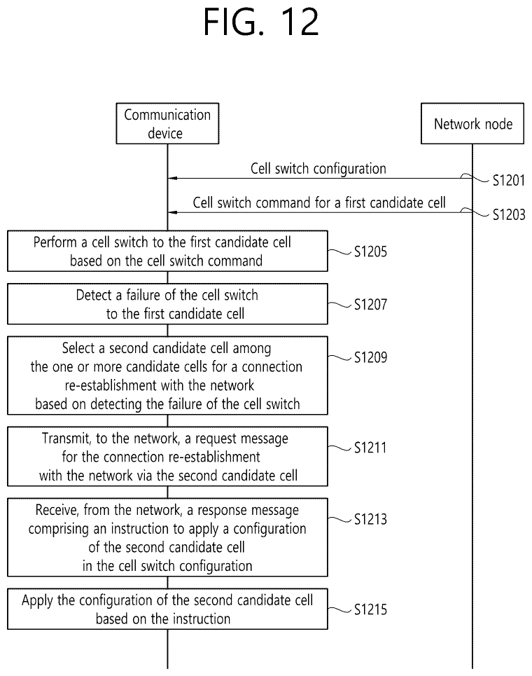

FIG. 12 shows an example of a procedure for connection recovery when cell switch failure occurs according to an embodiment of the present disclosure.

Referring to FIG. 12, in step S1201, network node may transmit, to a communication device, a cell switch configuration comprising one or more configurations of one or more candidate cells.

In step S1203, the communication device may transmit, to the communication device, a cell switch command for a first candidate cell among the one or more candidate cells.

In step S1205, the communication device may perform a cell switch to the first candidate cell based on the cell switch command.

In step S1207, the communication device may detect a failure of the cell switch to the first candidate cell.

In step S1209, the communication device may select a second candidate cell among the one or more candidate cells for a connection re-establishment with the network based on detecting the failure of the cell switch.

In step S1211, the communication device may transmit, to the network, a request message for the connection re-establishment with the network via the second candidate cell.

In step S1213, the communication device may receive, from the network, a response message comprising an instruction to apply a configuration of the second candidate cell in the cell switch configuration.

In step S1215, the communication device may apply the configuration of the second candidate cell based on the instruction.

Hereinafter, detailed implementations regarding connection recovery when cell switch failure occurs are described.

According to implementations of the present disclosure, while re-establishing RRC connection (i.e., while performing RRC (connection) re-establishment), if UE receives an indication from a network to use (pre)configuration corresponding to a cell which the UE selected for re-establishment of RRC connection, the UE may generate/construct a complete cell configuration based on the (pre)configuration and apply the complete cell configuration for the cell. After the UE applies the complete cell configuration successfully, the UE may send a response to the network to indicate the completion of the RRC re-establishment with the complete cell configuration based on the (pre)configuration.

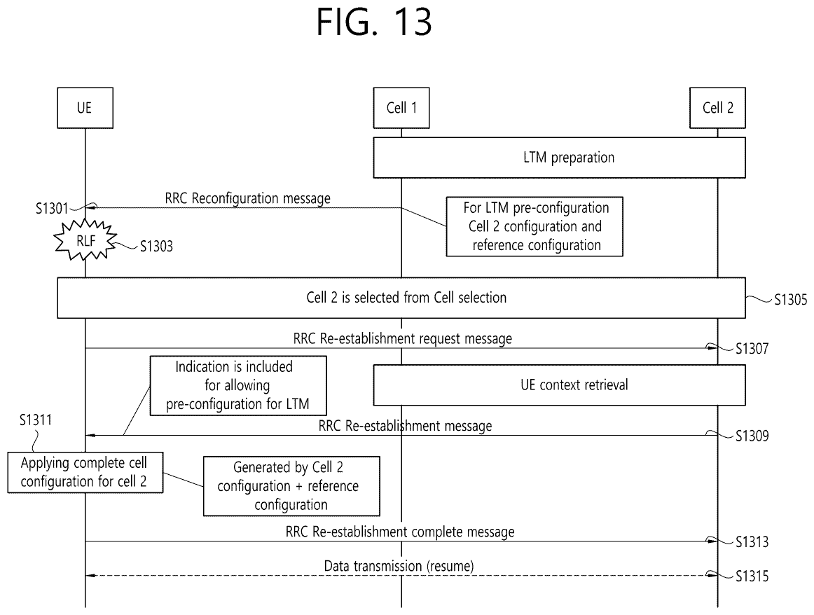

FIG. 13 shows an example of a procedure for RRC re-establishment enhancement based on LTM according to an embodiment of the present disclosure.

Referring to FIG. 13, in step S1301, UE may receive, from a serving cell (e.g., cell 1), RRC reconfiguration message comprising (pre)configuration (i.e., cell switch configuration). The (pre)configuration may comprise a configuration provided to perform L1/L2 signaling based cell switching (i.e., LTM) and/or conditional mobility (e.g., CHO, CPC, and/or CPA). In the (pre)configuration, there may be a list of one or more candidate cells corresponding candidate cell configuration(s) and/or reference configuration(s). That is, the (pre)configuration may comprise candidate cell configuration(s) and/or reference configuration(s) for the one or more candidate cells in the list. For example, the (pre)configuration may comprise a candidate cell configuration for cell 2 and/or reference configuration(s).

To generate the complete cell configuration based on the (pre)configuration, the UE may apply the corresponding candidate cell configuration to the corresponding reference configuration (i.e., candidate cell configuration+reference configuration). The corresponding candidate cell configuration and/or the corresponding reference configuration are included in the (pre)configuration. For example, UE may generate/construct the complete cell configuration for cell 2 based on applying the candidate cell configuration for cell 2 to the corresponding reference configuration.

The UE may receive, from the serving cell (e.g., cell 1), a cell switch command comprising a candidate configuration index of a target cell. Upon receiving the cell switch command, the UE may start an LTM supervisor timer. The LTM supervisor timer may be configured to the UE from the serving cell (e.g., cell 1) via RRC signalling. While the LTM supervisor timer is running, the UE may perform a cell switch to the target cell.

In step S1303, the UE may detect a radio link failure (RLF) and/or LTM (execution) failure. For example, the UE may detect RLF and/or LTM (execution) failure upon an expiry of the LTM supervisor timer. Upon detecting the failure and/or the expiry of the LTM supervisor timer, the UE may initiate RRC re-establishment with network.

In various embodiments, the RRC re-establishment can be declared/initiated by the UE when at least one of the following conditions is met:
1) upon detecting radio link failure of the MCG and t316 is not configured;
2) upon detecting radio link failure of the MCG while SCG transmission is suspended;
3) upon detecting radio link failure of the MCG while PSCell change or PSCell addition is ongoing;
4) upon detecting radio link failure of the MCG while the SCG is deactivated;
5) upon re-configuration with sync failure of the MCG;
6) upon mobility from NR failure;
7) upon integrity check failure indication from lower layers concerning SRB1 or SRB2, except if the integrity check failure is detected on the RRCReestablishment message;
8) upon an RRC connection reconfiguration failure;
9) upon detecting radio link failure for the SCG while MCG transmission is suspended;
10) upon reconfiguration with sync failure of the SCG while MCG transmission is suspended;
11) upon SCG change failure while MCG transmission is suspended;
12) upon SCG configuration failure while MCG transmission is suspended;
13) upon integrity check failure indication from SCG lower layers concerning SRB3 while MCG is suspended;
14) upon T316 expiry; and/or
15) upon failure of L1/L2 signaling based cell switching (i.e., LTM failure/upon an expiry of the LTM supervisor timer).

Upon/after initiating the RRC re-establishment procedure (or, during the RRC re-establishment procedure upon/after after initiating the procedure), in step S1305, the UE may perform a cell selection. It is assumed that cell 2 is selected from the cell selection.

In step S1307, the UE may transmit, to the selected cell (e.g., cell 2), an RRC re-establishment request message.

In step S1309, the UE may receive, from the selected cell (e.g., cell 2), an RRC re-establishment message as a response message for the RRC re-establishment request message. The RRC re-establishment message may comprise an indication to use the (pre)configuration. For example, during the RRC re-establishment procedure, the network may include the indication to use the (pre)configuration in the RRC re-establishment message after reception of the RRC re-establishment request message.

In step S1311, the UE may apply the complete cell configuration for the selected cell (e.g., cell 2). The complete cell configuration for cell 2 may be generated/constructed by applying the candidate cell configuration for cell 2 to the corresponding reference configuration.

In step S1313, during the RRC re-establishment procedure, the UE may transmit RRC re-establishment complete message to the network to indicate the completion of the RRC re-establishment with the cell configuration based on the (pre)configuration (i.e., complete cell configuration for cell 2).

Alternatively, if the network doesn't provide the indication to use the (pre)configuration while re-establishing RRC connection (e.g., RRC re-establishment message doesn't include the indication), the UE may remove the (pre)configuration and wait for the first RRC reconfiguration message for data transmission.

In step S1315, the UE may perform/resume a data transmission with the network via cell 2.

Furthermore, the method in perspective of the communication device described in the present disclosure (e.g., in FIG. 11) may be performed by the first wireless device 100 shown in FIG. 2 and/or the UE 100 shown in FIG. 3.

More specifically, the communication device comprises at least one transceiver, at least processor, and at least one computer memory operably connectable to the at least one processor and storing instructions that, based on being executed by the at least one processor, perform operations.

The operations comprise: receiving, from a network, a cell switch configuration comprising one or more configurations of one or more candidate cells; receiving, from the network, a cell switch command for a first candidate cell among the one or more candidate cells; performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

Furthermore, the method in perspective of the communication device described in the present disclosure (e.g., in FIG. 11) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a cell switch configuration comprising one or more configurations of one or more candidate cells; receiving, from the network, a cell switch command for a first candidate cell among the one or more candidate cells; performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

Furthermore, the method in perspective of the communication device described in the present disclosure (e.g., in FIG. 11) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., communication device/UE) comprises at least processor, and at least one computer memory operably connectable to the at least one processor. The at least one processor is configured to/adapted to perform operations comprising: receiving, from a network, a cell switch configuration comprising one or more configurations of one or more candidate cells; receiving, from the network, a cell switch command for a first candidate cell among the one or more candidate cells; performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

Furthermore, the method in perspective of a network node described in the present disclosure (e.g., in FIG. 12) may be performed by the second wireless device 200 shown in FIG. 2. The network node may be related to a serving cell.

More specifically, the network node comprises at least one transceiver, at least processor, and at least one computer memory operably connectable to the at least one processor and storing instructions that, based on being executed by the at least one processor, perform operations.

The operations comprise: transmitting, to a communication device, a cell switch configuration comprising one or more configurations of one or more candidate cells; and transmitting, to the communication device, a cell switch command for a first candidate cell among the one or more candidate cells, wherein the communication device is configured to perform operations comprising: performing a cell switch to the first candidate cell based on the cell switch command; detecting a failure of the cell switch to the first candidate cell; selecting a second candidate cell among the one or more candidate cells for a connection re-establishment with the network based on detecting the failure of the cell switch; transmitting, to the network, a request message for the connection re-establishment with the network via the second candidate cell; receiving, from the network, a response message comprising an instruction to apply a configuration of the second candidate cell in the cell switch configuration; and applying the configuration of the second candidate cell based on the instruction.

The present disclosure may have various advantageous effects.

For example, UE performs RRC re-establishment but can resume data transmission based on the given (pre)configuration (e.g., cell switch configuration) when RRC re-establishment procedure is completed. Thus, the UE can reduce the delay/latency of the data transmission than the case that the UE can start data transmission after reception of the first RRC reconfiguration after RRC re-establishment.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network, a cell switch configuration comprising one or more configurations of one or more candidate cells;
receiving, from the network, a cell switch command for a first candidate cell among the one or more candidate cells;
performing a cell switch to the first candidate cell based on the cell switch command;
detecting a failure of the cell switch to the first candidate cell;
selecting a second candidate cell among the one or more candidate cells for a connection re-establishment with the network based on detecting the failure of the cell switch;
transmitting, to the network, a request message for the connection re-establishment with the network via the second candidate cell;
receiving, from the network, a response message comprising an instruction to apply a configuration of the second candidate cell in the cell switch configuration; and
applying the configuration of the second candidate cell based on the instruction.

2. The method of claim 1, wherein the configuration of the second candidate cell in the cell switch configuration comprises a complete cell configuration for the second candidate cell, and
wherein the applying of the configuration of the second candidate cell comprises applying the complete configuration for the second candidate cell.

3. The method of claim 1, wherein the configuration of the second candidate cell in the cell switch configuration comprises a candidate configuration for the second candidate cell, and
wherein the applying of the configuration of the second candidate cell comprises:
constructing a complete configuration for the second candidate cell based on applying the candidate configuration for the second candidate cell to a reference configuration related to at least one of the candidate configuration or the second candidate cell; and
applying the complete configuration for the second candidate cell.

4. The method of claim 3, wherein the reference configuration is received from the network or derived from a current configuration.

5. The method of claim 4, wherein the reference configuration is included in the cell switch configuration.

6. The method of claim 1, further comprising starting a timer upon receiving the cell switch command for the first candidate cell,
wherein the performing of the cell switch to the first candidate cell comprises performing the cell switch to the first candidate cell while the timer is running, and
wherein the detecting of the failure of the cell switch comprises detecting the failure of the cell switch to the first candidate cell upon an expiry of the timer.

7. The method of claim 1, wherein the detecting of the failure of the cell switch comprises detecting a radio link failure (RLF) on a source cell related to the cell switch.

8. The method of claim 1, wherein the connection re-establishment comprises a radio resource control (RRC) re-establishment,
wherein the request message comprises RRC re-establishment request message, and
wherein the response message comprises RRC re-establishment message.

9. The method of claim 1, further comprising:
after applying the configuration of the second candidate cell, transmitting, to the network, a complete message informing a completion of the connection re-establishment which is based on the configuration of the second candidate cell.

10. The method of claim 9, wherein the complete message comprises a radio resource control (RRC) re-establishment complete message.

11. The method of claim 1, wherein the method is performed by a communication device in communication with at least one of a user equipment (UE), a mobile device, a network, or autonomous vehicles.

12. A communication device comprising:
at least one transceiver;
at least one processor; and
at least one memory operatively coupled to the at least one processor and storing instructions that, based on being executed by the at least one processor, perform operations comprising:
receiving, from a network, a cell switch configuration comprising one or more configurations of one or more candidate cells;
receiving, from the network, a cell switch command for a first candidate cell among the one or more candidate cells;
performing a cell switch to the first candidate cell based on the cell switch command;
detecting a failure of the cell switch to the first candidate cell;
selecting a second candidate cell among the one or more candidate cells for a connection re-establishment with the network based on detecting the failure of the cell switch;
transmitting, to the network, a request message for the connection re-establishment with the network via the second candidate cell;
receiving, from the network, a response message comprising an instruction to apply a configuration of the second candidate cell in the cell switch configuration; and
applying the configuration of the second candidate cell based on the instruction.

13. The communication device of claim 12, wherein the configuration of the second candidate cell in the cell switch configuration comprises a complete cell configuration for the second candidate cell, and
wherein the applying of the configuration of the second candidate cell comprises applying the complete configuration for the second candidate cell.

14. The communication device of claim 12, wherein the configuration of the second candidate cell in the cell switch configuration comprises a candidate configuration for the second candidate cell, and
wherein the applying of the configuration of the second candidate cell comprises:
constructing a complete configuration for the second candidate cell based on applying the candidate configuration for the second candidate cell to a reference configuration related to at least one of the candidate configuration or the second candidate cell; and
applying the complete configuration for the second candidate cell.

15. The communication device of claim 12, wherein the connection re-establishment comprises a radio resource control (RRC) re-establishment,
wherein the request message comprises RRC re-establishment request message, and
wherein the response message comprises RRC re-establishment message.

16. The communication device of claim 12, wherein the operations further comprise after applying the configuration of the second candidate cell, transmitting, to the network, a complete message informing a completion of the connection re-establishment which is based on the configuration of the second candidate cell,
wherein the complete message comprises a radio resource control (RRC) re-establishment complete message.

17. A network node comprising:
at least one transceiver;
at least one processor; and
at least one memory operatively coupled to the at least one processor and storing instructions that, based on being executed by the at least one processor, perform operations comprising:
transmitting, to a communication device, a cell switch configuration comprising one or more configurations of one or more candidate cells; and
transmitting, to the communication device, a cell switch command for a first candidate cell among the one or more candidate cells,
wherein the communication device is configured to perform operations comprising:
performing a cell switch to the first candidate cell based on the cell switch command;
detecting a failure of the cell switch to the first candidate cell;
selecting a second candidate cell among the one or more candidate cells for a connection re-establishment with the network based on detecting the failure of the cell switch;
transmitting, to the network, a request message for the connection re-establishment with the network via the second candidate cell;
receiving, from the network, a response message comprising an instruction to apply a configuration of the second candidate cell in the cell switch configuration; and
applying the configuration of the second candidate cell based on the instruction.

18. (canceled)

19. (canceled)

20. (canceled)

21. (canceled)
